(19) United States
(12) Patent Application Publication
(10) Pub. No.: US 2011/0078979 A1
(43) Pub. Date: Apr. 7, 2011

(54) Method for replacing tools in a packaging and storage system, computer program for this purpose and packaging and storage system

(75) Inventor: Alban Hutter, Reit im Winkl (DE)

(73) Assignee: KRONES AG, Neutraubling (DE)

(21) Appl. No.: 12/924,397

(22) Filed: Sep. 27, 2010

(30) Foreign Application Priority Data
Oct. 1, 2009 (DE) 10 2009 044 163.8

(51) Int. Cl. B65B 59/04; G06F 19/00

(52) U.S. Cl. 53/201; 29/401.1; 700/214

(57) ABSTRACT

A method and a computer program for converting a packaging line. A packaging and storage system for combining and packing and/or repacking of articles.

With the method according to the invention at hand it is being determined on the basis of the desired composition of articles, which tools are required in the packaging line and a respective data processor controlled replacement of the tools is carried out in the packaging line. The removed and no longer needed tools are placed in storage afterwards.

This claims the benefit of German Patent Application 10 2009 044 163.8, filed Oct. 1, 2009 and hereby incorporated by reference herein.

The present invention relates to a method and a computer program for replacing tools in a packaging line as well as a respective device.

### BACKGROUND

Filled containers of beverages, particularly filled bottles, are combined to packs for easier transport and sales purposes. For the most part said packs comprise an even number of alike articles, preferably are six, eight or twelve articles packed to such a unit and wrapped with a shrink film or with an outer packaging made of cardboard, for example.

DE 42 16 721 A1 discloses a packing system for moving bottles and cans in and out of crates wherein said packing system has a conveyor system for crates following a circulating path of grippers which pick up and put down bottles continuously. The conveyor direction of the crates constantly changes during the movement in the circulating path of the grippers and even when moved out of this path. The movements of the grippers and articles being picked up is synchronised with each other. The speed of the grippers on the circulating path is variable and slows down as the articles are picked up. The crate conveyor moves underneath the grippers and adjoins in a tangential extension conveyor for incoming crates and in a conveyor for outgoing crates.

DE 37 32 283 C1 describes an apparatus for loading and unloading of articles which are arranged in a packed manner with a gripper head, which is definable in a removable manner on a supporting frame and can be operated by means of a movable support arm. The apparatus is provided with a magazine which is situated next to the supporting frame, wherein said magazine has several trays for a gripper head in each case and lies within the motion field of the supporting frame. Thus, a mechanized and automated change of the gripper head is possible. Furthermore, it might be required that the articles are combined according to a desired formation as far as the transport to the client—to a beverage retailer for example—is concerned. A certain number of packs marked X of a first beverage type and a certain number of packs marked Y of a second beverage type are requested, for instance.

Mixed packs with bottles having different contents which are to be combined in a respective manner is what also might be possible. The combination and packing of such mixed packs is carried out in an automated way in a packaging line. The articles to be packed are generally fed to the packaging line via transport units, for example via endless conveyors.

DE 20 2005 019 906 U1 describes a mixed packing system for forming mixed packs of general cargo, which consists of at least two conveyor lines for packs and a line spanning converter, wherein the converter is provided with a gripper unit for the packs.

DE 10 2005 039 842 A1 describes a method for producing mixed packages and a device for carrying out said method. The invention relates to a method for forming mixed packages from sorted packages comprising, respectively, a container or similar packaging units which are received in an external packaging. The sorted packages are guided to an unpacking machine by at least one transporter. Said packages, which comprise one and the same products, are arranged on each transporter. The containers are arranged on at least one buffer section after unpacking and subsequently put together in order to form mixed packages. According to the invention, the containers of different types, which form a mixed package, are compiled either in several working steps, whereby a working step is produced for each reserved buffer section and the containers are withdrawn from only one buffer section in a working step or are put together in only one working step. The containers forming the mixed packages are provided simultaneously from several buffer sections.

EP 0 729 888 A1 shows a method and device for the automatic feeding of cardboard blanks. The process supplies cardboard sections for packing groups of objects, such as bottles in compartmentalised packaging. The sections are stored in a magazine in a packing machine, which is also supplied with the objects to be packed. The sections are initially available in a stack on a pallet. The sections are removed individually from the stack by additional equipment, and are fed to the magazine by a transport system. The sections may be combined into a group following individual removal from the stack, before being fed to the magazine, and they may also be combined so that they overlap.

DE 34 39 908 A1 describes machines for folding cardboard boxes from flat blanks.

The invention relates to a machine for folding cardboard boxes from flat blanks, with a multi-arm feeding device, the arms of which can be rotated in steps about their common axis of symmetry. A gripping element is located at the end of each arm. A blank magazine and a folding station are arranged in such a way that one gripping element is situated above the top blank in the magazine and one above the folding station at the end of each rotary step. The feeding device can be lowered in this position, one gripping element taking hold of a blank and the other gripping element pressing a blank into the folding construction of the folding station.

DE 34 00 822 A1 discloses a method for packing groups of goods in a folding box and a device for executing the method in which a group of articles combined into a packaging unit is placed onto an unfolded box blank, and this box blank is folded round the group of articles and closed to form a box and is finally transported away, characterized in that a box blank is fed intermittently to a loading station, from a first direction, in that a group of articles is fed intermittently to this loading station from a second feed direction opposite to the first direction and is placed on the box blank, and in that the box blank loaded with the group of articles is removed from the loading station in a third direction at least approximately perpendicular relative to the said first and second directions, the feed of the box blank and the feed of the group of articles; being carried out by means of a common feed member.

Different types of tools are needed, so that the packaging line can compose different articles to the desired packs and mixed packs respectively. Said tools need to be replaced according to the desired packs and/or mixed packs.

DE 195 10 498 A1 shows a tool interchange arrangement for machine tools especially for milling machines. The store consists of several separate sections and a change-over column which can be moved along the stores. A slide with grips can be moved vertically along the column and horizontally between store and machine tool. The separate store sections can each be rotated about a vertical centreline so that they line-up tool store positions which are mounted around the store. The stores can be rotated to bring one position within the range of the grip while another position is remote from the grip and onto which a tool can be loaded or on which a tool can be replaced by a new one.

WO 2007/147969 A2 describes an installation for packing objects such as bottles of different designs. The packing installation comprises a handling head in which tulip-like gripping tools are connected to said head by means of couplers which can be deactivated to allow them to be changed and replaced with tools suitable for different designs of bottles. The installation comprises a magazine in which may be housed at least two separate groups of tools, which magazine comprises a multitude of presentation units suited to the shapes and dimensions of said tools, which presentation units consist of a spindle to accommodate said tools, which spindle is of the floating type to give some flexibility and more importantly to engage with said tools not only during the depositing operation but also during the operation of gripping them; the magazine is mobile and is mounted on tracks to enable it to move between its inactive position, away from the field of action of the bottle handling head, and its active position within the said field of action of said head and in particular at the station where the bottles are picked up by said head.

### SUMMARY OF THE INVENTION

It is an object of the present invention to convert a packaging line in a controlled manner.

The present invention provides a method for converting a packaging line. The packaging line is provided with at least one first stockyard for articles to be packed (particularly for filled bottles or packs of filled bottles) and with at least a second stockyard for the tools of the packaging line. The tools for the packaging line are for example gripper heads adapted on different bottle types and bottle sizes respectively, tools for folding cardboards and so on.

The stockyards are high-bay warehouses, for example. The first stockyard for the articles and the second stockyard for the tools are arranged according to a preferred embodiment together in one high-bay warehouse and are jointly managed. Thus, such a joined high-bay warehouse can store palletizing storing positions, pallets with articles, pallets with tools or also with packaging material, for example.

At least two separated high-bay warehouses can be used according to an alternative embodiment, wherein the articles to be packed and/or repacked are stored and stocked in a first high-bay warehouse and the different tools for the packaging line are arranged in a second high-bay warehouse.

With the method according to the invention, the desired composition of articles is firstly fed into a data processor. Thereupon the data processor determines the desired tool loading of the packaging line necessary for the composition of articles. The determined desired tool loading is being compared with the actual tool loading of the packaging line. Said comparison is either carried out by an operator or directly by the data processor. If a difference is detected, then the data processor or the operator determine the tools supplied for the supply of the desired tool loading of the packaging line and the tools removed from the packaging line. That is that the data processor determines which tools may remain in the packaging line and which tools need to be replaced. What also might be possible is that the operator determines the difference and types in a respective control command into a respective control unit, wherein the respective tools are requested from the stockyard due to the control command and supplied to the packaging line.

Afterwards, a data processor can control the removal of the determined tools necessary for the conversion off the second stockyard for the tools. The requested tools are transported to the packaging line and replaced at the packaging line so that the packaging line is then provided with the determined desired tool loading.

The replacement of the tools at the packaging line can be carried out manually by an operator, for instance. The replacement of the tools at the packaging line is carried out in an automated manner according to a preferred alternative embodiment, for example by means of a robot allocated to the packaging line.

The replaced, removed and no longer needed tools can afterwards be backhauled to the second stockyard and stored there therein. Thus, the space in and about the packaging line is kept free from not needed tools.

The removal of the articles necessary for the desired composition of articles can be carried out according to an embodiment from the first stockyard likewise in a data processor controlled manner. The data processor particularly determines the articles necessary for the desired composition of articles and number of composed articles, and controls the timely adapted removal of the articles from the stockyard.

The articles to be composed together, especially the articles to be commissioned together, are provided in a first stockyard, for example in a high-bay warehouse. Furthermore, the necessary packaging material can be stocked in a stockyard, wherein said stockyard is either positioned directly at the packaging line or connected with said packaging line via a transport system. The packaging materials are for instance cardboard blanks, crates, partitions or the like.

The articles and/or the tools and/or the packaging material are transported according to an embodiment by means of transport carriers via a transport system from the stockyard to the packaging line. In this connection, the loaded transport carriers are lifted by means of a lifting device and guided in guiding rails from the stockyard to the packaging line. The articles and/or the tools and/or the packaging material are delivered to the packaging line and the unloaded transport carriers are lowered and returned in transport rails from the packaging line to the high-bay warehouse, wherein said transport carriers backhaul not needed tools of the packaging line to the stockyard, if necessary.

The present invention also provides a computer program for operating a packaging and storage system. The packaging and storage system comprises at least one packaging line for combining and packing or repacking of articles, particularly of filled bottles and/or packs of filled bottles. Furthermore, the packaging and storage system comprises at least one stockyard for storing articles, particularly for stocking bottles of different type and/or different content. The packaging and storage system is in addition provided with at least a second stockyard for storing tools for the packaging line, since the tool equipment of the packaging line must be in each case adapted according to the articles to be packed and or repacked respectively.

After inputting the desired composition of articles, the computer program determines the desired tool loading of the packaging line necessary for the composition of articles and compares said desired tool loading with the actual tool loading of the packaging line. The tools supplied to the packaging line and the tools removed from the packaging line are determined on the basis of the resulting difference. Besides, the software can serve the purpose to control the removal of the determined tools from the second stockyard necessary for the conversion and the conversion of the tools at the packaging line.

According to a further embodiment, the computer program controls in addition the backhaul of the tools removed from the packaging line which are not needed for forming the desired composition of articles, and the stocking of said removed tools at the second stockyard.

Furthermore, the present invention provides a packaging and storage system for composing and packing and/or repacking articles. The invention preferably refers to a packaging and storage system for forming mixed packs of bottles of different type and/or content and for forming mixed big packs of packs of bottles of different type and/or content respectively.

The packaging and storage system comprises a centralized data processor, at least one stockyard for the articles to be packed and/or for tools for the packaging line and/or for packaging material, further a transport system for the transport of articles and/or of the tools and/or of the packaging material as well as a packaging line for composing and packing of the articles. The centralized data processor serves in this case for the control of the tool conversion and the transport of tools between the at least one stockyard and the packaging line.

The tools for the packaging line are provided according to the invention with an identification means, wherein the information stored and displayed therein respectively can be read out by means of a recognizing unit and thus serves for easy identification of the different tools.

The tools are provided according to the invention in each case with a RFID chip, which is a so called transponder. The packaging line comprises a receiver which can read out the data stored on the RFID chip via radio communication and can thus easily determine the actual tool loading. The determined data are sent to a data processor, for instance, which hence determines the difference between desired tool loading and actual tool loading.

The tools are provided according to a further alternative embodiment with a bar code. The data displayed by the bar code are automatically read out and electronically processed by optical reading apparatuses which are arranged in the packaging line and/or in the high-bay warehouse, wherein said optical reading apparatuses are scanners or cameras, for example.

It is also possible that an operator manually identifies the tools with a respective detection unit and enters the respective information into a control unit, for instance, wherein said control unit then controls the removal of the necessary tools from the stockyard.

Regarding the stockyard and the transport systems it is referred to the above description.

The packaging line can be built in a modular way, which is that the combination and packing of combinations of articles is then carried out automated by means of different packing modules which are combined to a packaging line. Thus, the packaging line consists of different modules for the combination and packing and repacking respectively of articles, wherein each module is freely replaceable. A module for grouping, a module for wrapping the grouped containers with film and a shrinking tunnel are combined subsequently to form a packaging line, for instance.

According to a further embodiment the articles are packed in cardboard packs. The respective packaging line comprises at least a cartoning module, which is being combined with a feeding module, an inserting module and at least a closing module, wherein at least one of the modules is provided with a pleating for the cardboard blanks.

Furthermore, modules can be provided, which supply tools in order to adapt the single modules of the packaging line to different articles to be packed or the like, for example.

### BRIEF DESCRIPTION OF THE DRAWINGS

Further features and advantages of the present invention shall now be described in greater detail according to the accompanying figures in the following detailed description. The dimensions of the individual elements to each other do not always correspond with the real dimensions since some forms are shown simplified and other forms are shown enlarged with respect to other elements for the sake of clarity.

FIG. 1 shows a schematic view of possibilities of how to compose articles (prior art);

FIG. 2 schematically shows an OFFLINE arrangement of a packaging and storing system;

FIG. 3 schematically shows the arrangement of a stockyard for tools in an OFFLINE arrangement of a packaging and storing system;

FIGS. 4A/B schematically shows a packaging line;

FIG. 5 shows an OFFLINE arrangement of a packaging and storing system;

FIGS. 6/7 show details of a toll changing system;

FIG. 8 shows the arrangement of a transport system;

FIG. 9 shows details of the transport system;

FIGS. 10 to 12 show tools for the packaging of pack.

### DETAILED DESCRIPTION

Same elements refer to same reference numbers throughout the various figures. Furthermore, only reference numbers which are necessary for the description of the respective figure are shown in the various figures for the sake of clarity. The shown embodiments are only examples of how the method according to the invention can be designed and shall not be regarded as limiting the invention.

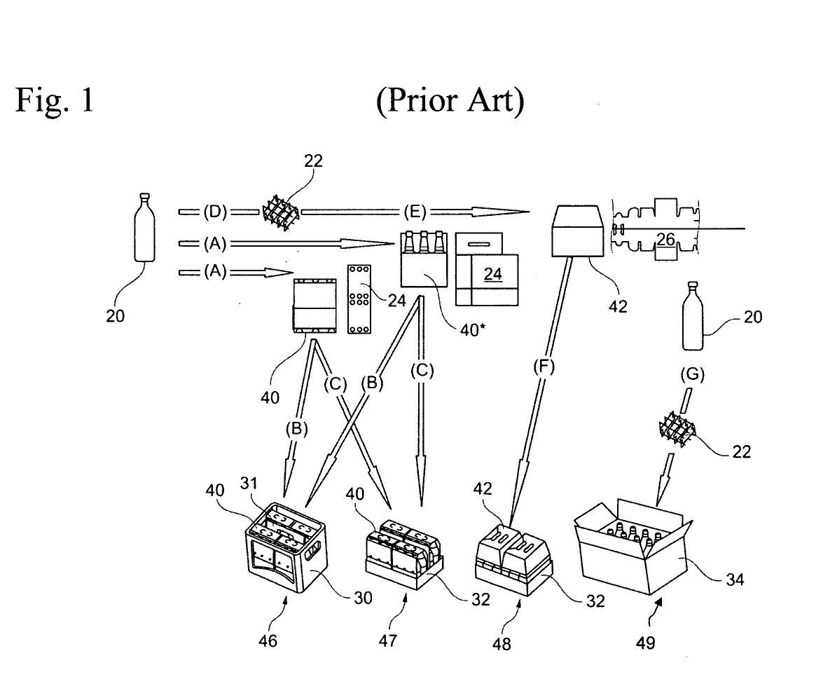

FIG. 1 shows a schematic view of different possibilities of pack production. The articles to be packed, particularly bottles 20, are combined to packs 40, 40* having six bottles 20, for instance, and packed in folded packages with partitions 24, so that the bottles 20 are secured safely in the folded package 24 and do not abut (A) against each other during transport.

Afterwards, several packs 40, 40* can be arranged for example in an outer packaging 30 made of polymer with a supporting strap 31 to a big pack 46 (B), or can be arranged on a sort of tray 32 with a heightened rim to a big pack 47.

In order to ensure that the formation consisting of several packs 40, 40* on a tray 32 (please see (C)) keeps together during transport, it is possible, to secure the formation with a further wrapping, for example in the form of a shrink film (not shown).

Furthermore it is possible, to arrange the bottles 20 in a partition 22 (D) and finally combine (E) said bottles in a folded package 26 to bigger packs 42, where twelve bottles 20 are combined, for instance. These packs 42 can be afterwards combined (F) again onto a tray 32 to big packs 48.

A further possibility of a pack formation (G) is to arrange the bottles 20 in a partition 22 and afterwards in a cardboard 34 and thus forming a big pack 49.

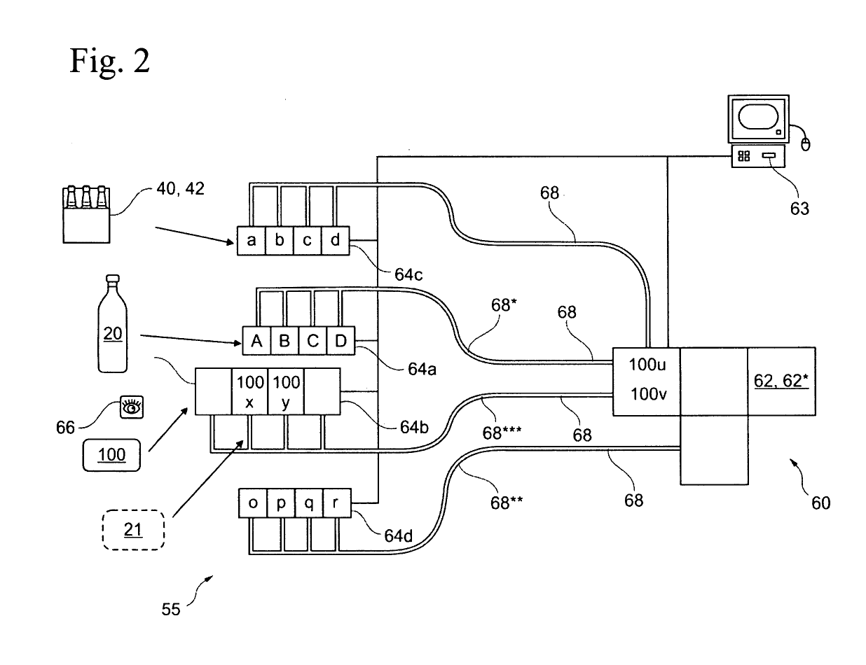

FIG. 2 schematically shows an OFFLINE arrangement of a packaging and storage system 55. An OFFLINE arrangement refers to an arrangement which servers as a repacking arrangement, in order to wrap the bottles, which are already combined in first packs, into the desired final packaging, if necessary. The shown OFFLINE-arrangement comprises at least a modular packaging line 60 with packaging modules 62, 62*, four high-bay warehouses 64a, 64b, 64c and 64d, and a transport system 68.

Filled bottles 20 or packs 40, 42, packaging material 21 (partitions for instance (22; please see FIG. 1), folded packages with and without partitions (24, 26; please see FIG. 1), and/or blanks for outer packaging made of cardboard or polymer (28,30; please see FIG. 1)), tools 100u, 100v, 100x, 100y for the packaging modules 62, 62* and so on are firstly stored in at least one automated high-bay warehouse 64b in the packaging and storage system 5. In the embodiment shown here, the different articles 20, 40, 42, tools 100u, 100v, 100x, 100y, packaging material 21 and so on are in each case stored in separated highbay warehouses 64a to 64d. Different bottles 20 of different type and, if necessary, different content A, B, C and D are stored in the high-bay warehouse 64a, for example, whereas different packs of bottles 40, 42 with different content a, b, c and d are stored in the high-bay warehouse 64c. Tools 100u, 100v, 100x, 100y for the packaging line 60, however, may be availably stored in the high-bay warehouse 64b and packaging material 21 in the high-bay warehouse 64d.

Depending on the order of the client, new packs or big packs are afterwards commissioned. In order to complete this task safely, an adaption of the tools 100u, 100v, 100x, 100y of the packaging line 60 is necessary. This adaption should be carried out possibly in a time-saving manner, in order to avoid longer downtimes of the packaging line 60. Therefore, the supply of the filled bottles 20 from the high-bay warehouse 64a, the changeover of the machines in the packaging line 60, particularly in the single packaging modules 62, 62*, and the replacement of removable tools 100u, 100v, 100x, 100y is at least partially operated in an automated and centralized manner according to the invention.

The automation is preferably controlled by a centralized control unit or controller 63. The control unit 63 is a computer, for instance, into which the desired composition of articles is fed and which carries out afterwards the changeover of the single modules 62, 62* by changing the tools 100u, 100v, 100x, 100y and furthermore controls the choice of products 20, 40, 42 and of the necessary packaging material 21, so that said products are fed via the transport system 68, for example via a bottle feed 68* of the packaging line 60.

The bottles 20 in the high-bay warehouse 64a are provided on pallets according to a further embodiment, wherein said pallets are fed via a special transport path 68 to the packaging line 60, wherein said transport path 68 is adjusted to the width of the pallets, if necessary.

Besides, robot cells 66 can be coupled with the transport system 68, in order to place the product related tools 100x, 100y—for example special gripping tools, special folding tools, respective product, collets, cardboard guides and so on—into the packaging line 60. Hence, the packaging of a great number of different products 20, 40, 42 is possible.

A centralized high-bay warehouse 64 or several single high-bay warehouses 64a, 64b, 64c and 64d are allocated to the packaging line 60 according to the shown embodiment. The high-bay warehouse 64 is connected with the packaging line 60 via a transport system 68, which is provided, for instance, with pallets or the like as consistent transport carriers. The product to be packed, for example bottles 20 or packs 40, 42 is fed via these transport carriers to the packaging line 60 via first transport paths 68*, and the necessary packaging material 21 is fed via second and, if necessary, further transport paths 68** from the high-bay warehouse 64c (o, p, q, r).

The necessary tools 100x, 100y are preferably fed via third transport paths 68*** to the packaging line 60. This is conducted in the same way as already described above. That is that the control unit 63 indicates or that a robot cell 66 recognizes which products 20, 40, 42 are to be processed. This results in which tool 100x, 100y is necessary and said tool is being automatically requested from the high-bay warehouse 64, 64b and loaded at a stockyard onto the transport carrier—onto a pallet, for instance. The transport carrier is forwarded via the transport system 68, 68*** to the packaging line 60 and thus the tool 100x, 100y is transported to the packaging line 60.

The tools 100x, 100y which arrive at the packaging line 60 can be adjusted manually by an operator, that is that the operator removes the tools 100x, 100y from the transport carrier and inserts said tools into the respective module 62, 62* of the packaging line 60 and replaces them with the tools 100u, 100v respectively. Alternatively, the transport carrier can also be directly moved into the respective module 62, 62* of the packaging line 60, where a suitable robot independently grabs the respective tools 100x, 100y after having independently removed the previously used tools 100u, 100v and having placed said removed tools onto a transport carrier for automated backhaul into the high-bay warehouse 64, 64b.

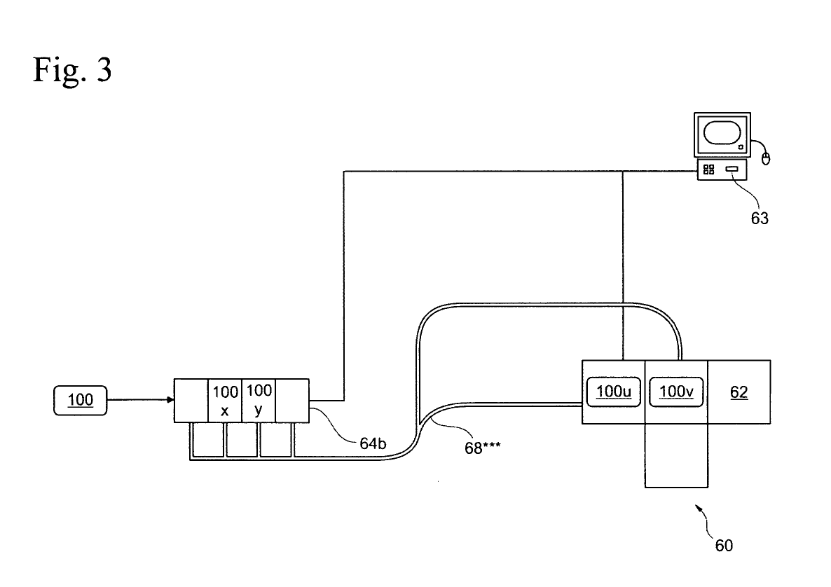

FIG. 3 schematically shows once again the arrangement of a stockyard for tools 100x, 100y in a packaging and storage system 55. The tools 100x, 100y are situated in a stockyard, for example in a high-bay warehouse 64b. This stockyard 64b is connected via a transport path 68*** with the packaging line 60. The packaging line 60 is equipped with the tools 100u, 100v. When the control unit 63 determines that other tools, for example the tools 100x, 100y are needed for the new desired composition of articles, then the control unit 63 enables that the tools 100x, 100y are removed from the high-bay warehouse 64b by means of targeted control and that the tools 110x, 100y are fed to the packaging line 60. Afterwards, the tools 100u, 100v are replaced with the tools 100x, 100y. The no longer needed tools 100u, 100v are backhauled to the high-bay warehouse 64b and stored there therein.

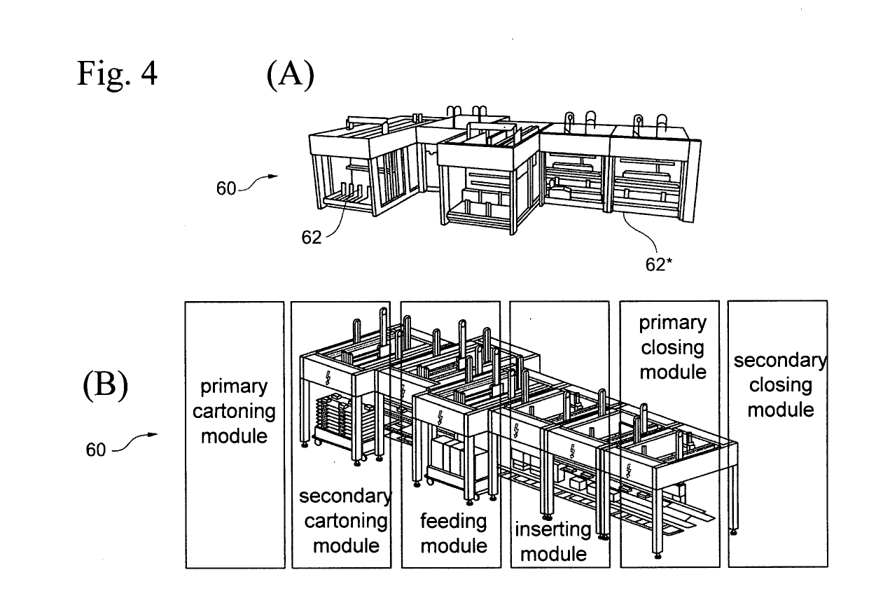

FIG. 4 shows a possible arrangement of a packaging line 60. The shown packaging line 60 is constructed in a modular manner, wherein the single packaging modules 62, 62* and further packaging modules according to the desired packs and their package (please see FIG. 1) are respectively combined and arranged.

The packaging line 60 consists of different modules 62, 62* for the packing and repacking of articles respectively, wherein each module is freely replaceable. A module for grouping, a module for wrapping the grouped containers with film and a shrinking tunnel can be combined subsequently to form a packaging line 60, for instance. Furthermore, modules 62, 62* can be provided in addition, which supply tools in order to adapt the single modules 62, 62* of the packaging line onto different articles to be packed or the like, for instance.

FIG. 4(B) shows the assembly of a modular packaging line 60 wherein the articles are combined into cardboard outer packaging. The shown packaging line 60 consists of a primary and a secondary cartoning module, a feeding module, an inserting module and a primary and a secondary closing module.

An advantage of the modular assembly is the consistent separation of the processing steps. The easy replacement of the tools 100, 100u, 100v, 100x, 100y, which is necessary only in one module 62, 62* if applicable, enables a large flexibility so that different articles can be combined in the most different packages.

Modular packaging lines 60 can be designed as so called INLINE packaging lines, that is that they are arranged directly in a line after the filling and labelling station. Furthermore, the usage of an OFFLINE arrangement is possible which serves as a repacking arrangement in order to wrap the bottles which are already combined in first packs into the desired final package if necessary.

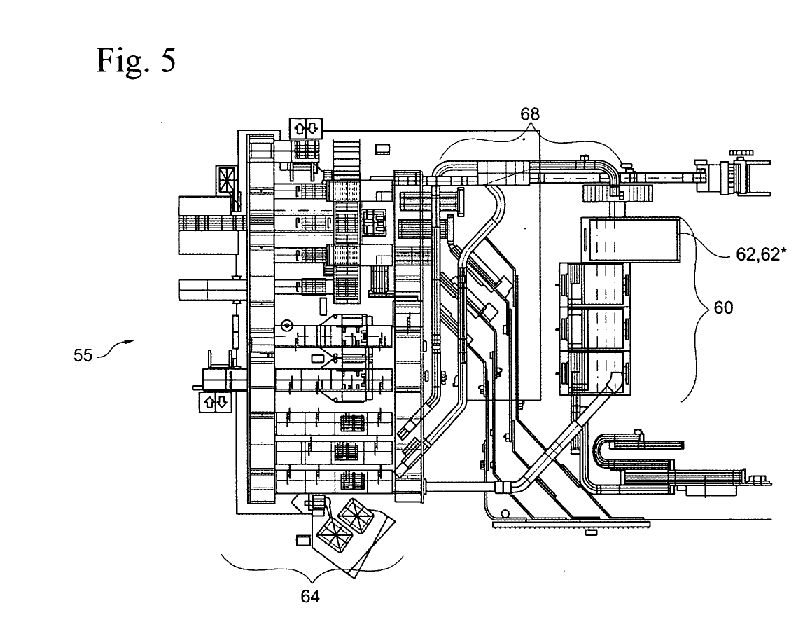

FIG. 5 shows once again a detailed view of an OFFLINE arrangement of a packaging and storage system 55. As for the description it is referred to FIG. 2 and FIG. 3.

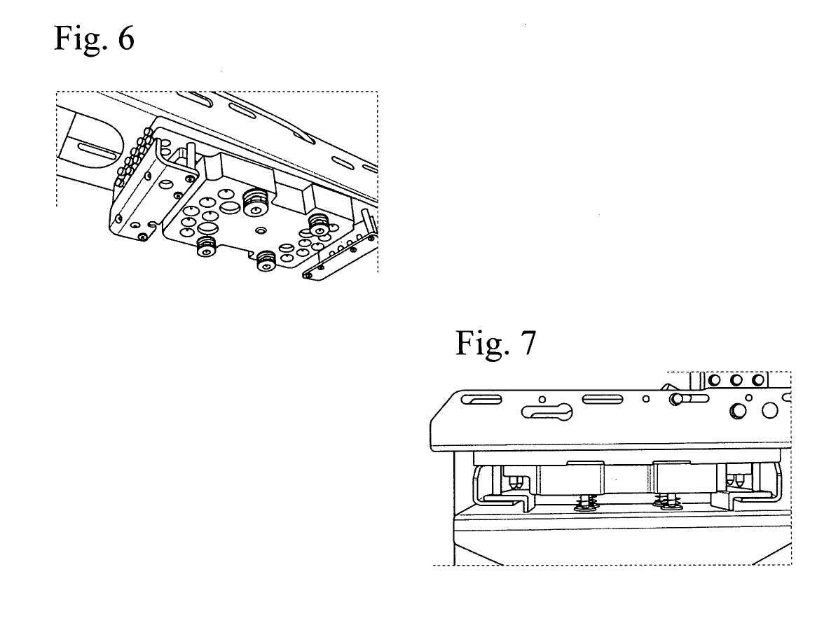

FIG. 6 and FIG. 7 show details of a tool exchange system. In this case an automated coupling system is concerned wherein a robot of the modules 62, 62* of the packaging line 60 independently grabs and recognizes the tools 100, 100u, 100v, 100x, 100y. This is different from known prior art, where the respective tools 100, 100u, 100v, 100x, 100y are positioned in the grab range of the robot and the replacement of the necessary tools 100, 100u, 100v, 100x, 100y is controlled by means of software.

The fixation of the tools 100, 100u, 100v, 100x, 100y is preferably carried out by the application of low-pressure. That is that the tool holder is provided with openings, by means of which low-pressure can be applied, so that the tools 100, 100u, 100v, 100x, 100y can be sucked on and fixed. This system enables a facilitated transfer of the tools 100, 100u, 100v, 100x, 100y, since it can be run fully automated. Due to certain computer controlled signals low pressure is applied on the tool holder and the tools 100, 100u, 100v, 100x, 100y are sucked on and fixed. By changing over to compressed air, the tools 100, 100u, 100v, 100x, 100y are then released in such a case from the tool holder.

Further fixations of the tools 100, 100u, 100v, 100x, 100y are also possible and encompassed by the invention. Screw connections of the tools 100, 100u, 100v, 100x, 100y with the tool holder are also imaginable particularly with manual replacement. Likewise, a hooking in respective fixation means at the tool holder is possible, this can even be carried out by a robot, if necessary.

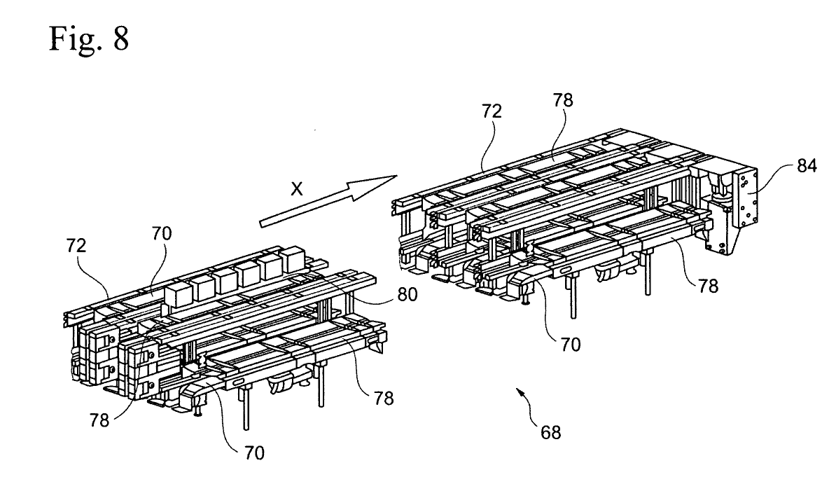

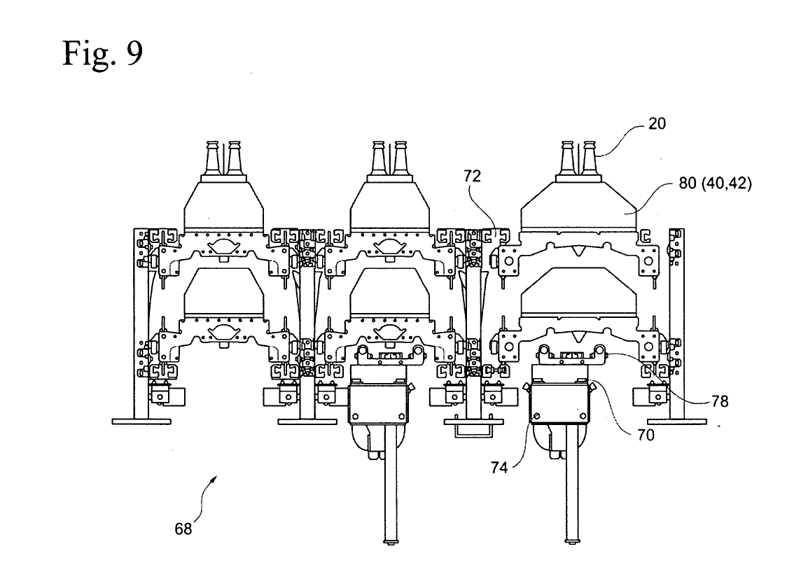

FIG. 8 shows the arrangement of a transport system 68 and FIG. 9 shows details of this transport system 68. The transport system 68 comprises transport rails 70 and guiding rails 72. The parts to be transported, that is the goods to be transported 80—said goods can be articles to be packed, for example bottles 20/packs 40, 42; tools 100, 100u, 100v, 100x, 100y or packaging material 21 and so on—are transported on transport carriers 78, which run on the transport rails 70. The transport carriers 78 are brought via a lifting device 74 onto the transport level of the guiding rails 72 and then coupled on a chain-drive or the like. After passing trough the transport system 68 in transport direction X, the transport carriers 78 are lowered at the junction 84 to the packaging line 60 and backhauled again via a chain return motion to the high-bay warehouse.

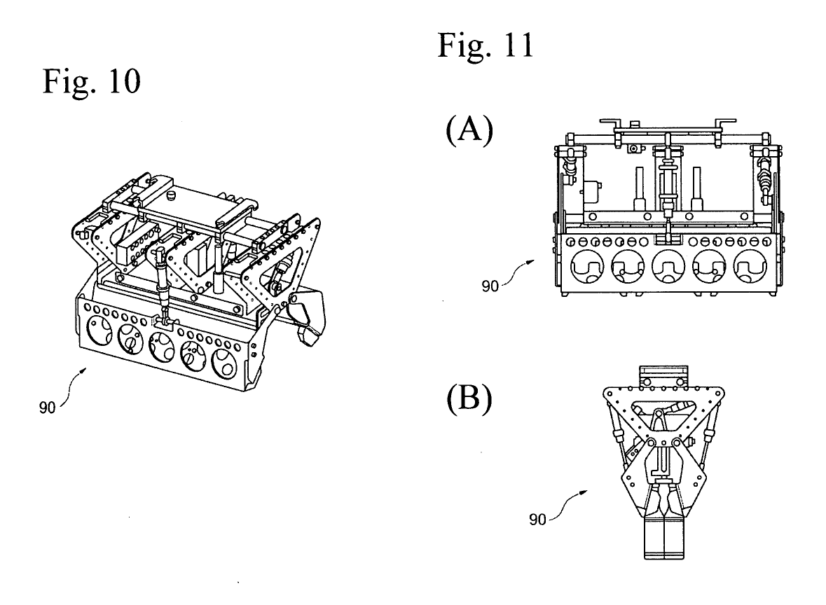

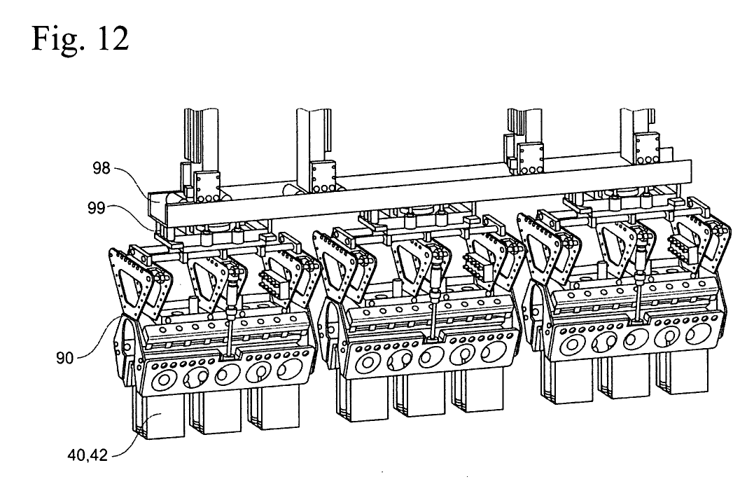

FIGS. 10 to 12 show exemplary special tools, which are inserted in the modules 62, 62* of the packaging line 60 (please see FIGS. 2 to 4) for the packing or repacking of articles and are fed to the modules 62, 62* via the above-described transport system 68. In this case a locking head 90 for locking cardboard about a pack of bottles 40, 42 is concerned.

The invention has been described with reference to preferred embodiments. To the person skilled in the art it is also conceivable, however, to make changes and modifications to the invention without leaving the scope of protection of the appended claims. The packaging line 60 does not need to be built in a modular 62, 62* manner. Instead of that it can be any packaging unit known from the prior art.

### LIST OF REFERENCE NUMBERS

20 bottles
21 packaging material
22 partition
24 folded package with partition
26 folded package without partition
28 outer packaging made of cardboard
30 outer packaging made of polymer/crate
31 supporting strap
32 tray
34 cardboard
40 pack of six bottles
40* pack of six bottles
42 pack of twelve bottles
46 big pack
47 big pack
48 big pack
49 big pack
55 packaging and storage system
60 packaging line
62 packaging module
62* packaging module
63 control unit
64, 64a-d high-bay warehouse
66 robot cells
68 transport system
68* bottle feed/first transport path
68** feed for packaging material/second transport path
68*** tool feed/third transport path
70 transport rails
72 guiding rails
74 lifting device
78 transport carrier
80 goods to be transported
84 junction to the packaging line
90 locking head
98 guiding rail
99 tool acceptance/tool carrier
100 tool for packaging line
100u,v,x,y tool for packaging line
X transport direction

What is claimed is:

1. A method for converting a packaging line comprises at least one first stockyard for articles to be packed and at least one second stockyard for tools, comprising the following steps:
feeding a desired composition of articles into a data processor;
determining using a data processor a desired tool loading of the packaging line necessary for the desired composition of articles;
comparing an actual tool loading of the packaging line to the determined desired tool loading;
determining first tools to be supplied for the desired tool loading of the packaging line and determining second tools to be removed from the packaging line on the basis of the comparing step;
removing using the data processor the first tools from the second stockyard, transporting the first tools to the packaging line for the supply of the determined desired tool loading, and replacing the second tools with the first tools; and
backhauling the second tools from the packaging line and storing the second tools in the second stockyard.

2. The method as recited in claim 1 wherein the comparison of the actual tool loading of the packaging line with the determined desired tool loading is carried out by the data processor.

3. The method as recited in claim 1 wherein the determination of the first tools and of the second tools is carried out by the data processor on the basis of the comparing step.

4. The method as recited in claim 1 wherein the actual tool loading is automatically removed and the determined desired tool loading automatically installed.

5. The method as recited in claim 1 wherein the packaging line is provided with at least one robot and wherein the robot is used for the automatic installation and removal of the first and second tools, respectively.

6. The method as recited in claim 1 wherein the removal of the articles necessary for the desired composition of articles is carried out in a data processor controlled manner from the at least one first stockyard.

7. A computer program for operating a packaging and storage system, the packaging and storage system comprising at least one packaging line, at least one first stockyard for articles and at least one second stockyard for tools for the packaging line and wherein the computer program after having been fed with a desired composition of articles, the computer program executing the following program steps:
determining a necessary desired tool loading of the packaging line for the composition of articles;
comparing an actual tool loading of the packaging line with the determined necessary desired tool loading;
determining first tools for the supply of the desired tool loading of the packaging line and determining second tools to be removed from the packaging line on the basis of the comparing step; and
controlling removal of first tools from the second stockyard, transport of the first tools to the packaging line and replacement of the second tools with the first tools for the supply of the determined desired tool loading.

8. The computer program as recited in claim 7 wherein the computer program controls the backhaul of the tools removed from the packaging line and the storage of said removed tools in the second stockyard.

9. A packaging and storage system for combining and packing and/or repacking of articles, comprising:
a centralized data processor;
at least one stockyard for the articles to be packed and/or for tools for the packaging line and/or for packaging material; and
a transport system and a packaging line, wherein the tool conversion and the transport of the tools between the at least one stockyard and the packaging line is controllable with the centralized data processor.

10. The packaging and storage system as recited in claim 9 wherein with the packaging and storage system packs of filled bottles of different type and/or content are combinable.

11. The packaging and storage system as recited in claim 9 wherein the tools for the packaging line are in each case provided with an identifier.

12. The packaging and storage system as recited in claim 11 wherein the packaging line is provided with a recognizing unit for data which is stored and/or transmitted by the identifier.

13. The packaging and storage system as recited in claim 10 wherein the at least one stockyard is a high-bay warehouse.

14. The packaging and storage system as recited in claim 10 wherein the transport system is provided with at least one transport carrier, at least one guiding rail, at least one transport rail and at least one lifting device.

15. The packaging and storage system as recited in claim 10 wherein the packaging line hat at least two packaging modules.
